(19) United States
(12) Patent Application Publication
(10) Pub. No.: US 2025/0101279 A1
(43) Pub. Date: Mar. 27, 2025

(54) OPTICALLY CLEAR (METH) ACRYLATE ADHESIVES HAVING IMPROVED SURFACE CURING

(71) Applicant: Henkel AG & Co. KGaA, Duesseldorf (DE)

(72) Inventors: Zhan Hang Yang, Rocky Hill, CT (US); Liam J. Gerety, Oxford, CT (US); Dingsong Feng, Needham, MA (US); Jiangbo Ouyang, Wallingford, CT (US)

(21) Appl. No.: 18/787,144

(22) Filed: Jul. 29, 2024

Related U.S. Application Data
(63) Continuation of application No. PCT/US2023/011667, filed on Jan. 27, 2023.
(60) Provisional application No. 63/304,021, filed on Jan. 28, 2022.

(51) Int. Cl. C09J 133/14; C08F 2/50; C08J 5/00; C08K 3/22; C08K 5/134; C09J 4/06

(52) U.S. Cl. CPC C09J 133/14; C08F 2/50; C08J 5/00; C08K 3/22; C08K 5/134; C09J 4/06; C08K 2003/2244

(57) ABSTRACT

UV curable (meth)acrylate compositions incorporating a thiol-containing component show increased surface reaction conversions and thus have improved, dry to the touch surface cure properties.

### TECHNICAL FIELD

The present disclosure relates to UV curable (meth)acrylate compositions which have improved surface curing when exposed to ambient air during photo-curing, thereby eliminating sticky surfaces and improving adhesion properties.

### BACKGROUND ART

Ultra-violet curing (meth)acrylate compositions are known not to easily cure at their surfaces in ambient air conditions due to photoinitiator quenching and free radical scavenging by oxygen molecules. In molding applications, where the mold surface is highly oxygen-permeable, such as in silicone rubber molds (e.g., polydimethylsiloxane (PDMS)), oxygen retards the UV cure efficiency, particularly at the mold adhesive interface. Additionally, certain mold-reinforcing additives such as silica commonly used in silicone and other molds, adds to this inefficiency by absorbing, scattering or blocking UV radiation and hence hindering complete surface cure.

Conventional strategies for reducing oxygen inhibition have resulted in yellowing of the final product, which is unacceptable in applications design for optical adhesives. For example, attempts to increase the photoinitiator concentration or choosing the type of photoinitiator have not been successful without introducing yellowing. Blends of surface-curing and depth-curing photoinitiators have resulted in yellowing as well. Other attempts to solve the surface cure issue have also resulted in lack of optical clarity, including for example, using wax as a barrier material (resulting in haze), using amines to promote curing (yellowing and color instability), using cationic free radical cure in place of UV cure (yellowing and color instability), as well as using triphenyl phosphine (results in haze).

The preparation methods and uses of non-yellowing, high refractive index optical adhesives have been previously described in various Henkel patent applications, including International Patent Application Publication Nos. WO 2018/170371 and WO 2019/000375, and U.S. Patent Application Publication No. US 2019/0218434.

It would be advantageous to provide a (meth)acrylate adhesive composition which had a high efficiency surface cure (dry to the touch) when photo cured in ambient air, and which also possesses a high refractive index and is and remains optically clear without visually observable yellowing.

### SUMMARY

The present invention incorporates into a UV curable (meth)acrylate adhesive composition a multi-functional-thiol in amounts of about 5% to about 40% by weight of the total composition, to produce higher oxygen resistance at the adhesive surface, and hence increased surface curing in the presence of oxygen during UV curing.

In one aspect of the invention there is provided an oxygen resistant, non-yellowing optical adhesive composition comprising a multi-functional component selected from the group consisting of a multi-functional thiol, a multi-functional thiol-vinyl ether, multi-functional thiol-allyl ether, and combination thereof, wherein the component is present in amounts of about 5% to about 40% by weight of the total composition; a multifunctional (meth)acrylate component; and a photoinitiator; wherein upon photo-curing the composition in the presence of oxygen at the adhesive surface, the compositions exhibit oxygen resistance as evidenced by a percent reaction conversion at the composition surface of at least 40%; and wherein the composition when cured has a refractive index (RI) of 1.6≥RI≥1.55.

In another aspect of the invention, there is provided a method of molding an oxygen resistant, non-yellowing optical adhesive composition to achieve a high percentage surface conversion including the steps of:
a. Discharging into an oxygen-permeable mold, an oxygen resistant, non-yellowing optical adhesive composition including
   a multi-functional component selected from the group consisting of a multi-functional thiol, a multi-functional thiol-vinyl ether, multi-functional thiol-allyl ether, and combination thereof, wherein the component is present in amounts of about 5% to about 40% by weight of the total composition;
   a multifunctional (meth)acrylate component; and
   a photoinitiator;
b. Photo-curing the composition in an oxygen permeable mold in the presence of oxygen to obtain a molded product which exhibits oxygen resistance as evidenced by a percent reaction conversion at the composition surface of at least 40% and which product has a refractive index (RI) of 1.6≥RI≤1.55.

In addition to UV curing, thermal curing may also be employed to further ensure full curing, if desired.

Upon photo-curing the composition in the presence of oxygen at the adhesive surface, the compositions exhibit oxygen resistance as evidenced by a reaction conversion at the adhesive surface of at least 60% when the adhesive surface is subjected to oxygen exposure, desirably at least 80% reaction conversion at the adhesive surface and more desirably at least about 90% reaction conversion at the adhesive surface.

Products made from the inventive compositions are useful in among such things as adhesive products, particularly those having optical clarity and good light stability.

### DESCRIPTION OF THE FIGURES

FIG. 1 is a reference graph of the absorbance/wavelength spectra of (meth)acrylates showing the wavenumbers at which C═C have their strongest absorption.

FIG. 2 is a graph of % surface reaction conversion test results over time for comparative compositions DF-10 and DF-13A, as well as inventive composition 97 (after just UV exposure) and 97A (after UV and thermal cure//UVT).

FIG. 3 is a graphic representation of % surface reaction conversion test results for inventive compositions 97D, 98A, 98D, 98E and 99B after only UV cure at UV/1635 cm− at three different test conditions namely: 1.) in ambient air without being covered by a layer of polymer; 2.) in ambient air covered by an oxygen permeable polydimethylsiloxane polymer (PDMS) to simulate a silicone rubber mold; and 3.) in ambient air covered by a gas permeable layer of polyethylene terephthalate (PET).

FIG. 4 is a graphic representation of % surface reaction conversion test results for inventive compositions 97D, 98A, 98D, 98E and 99B after UV cure at UV/1635 cm− followed by thermal cure at 100° C. for 1 hour at three different test conditions namely: 1.) in ambient air without being covered by a layer of polymer; 2.) in ambient air covered by an oxygen permeable polydimethylsiloxane polymer (PDMS) to simulate a silicone rubber mold; and 3.) in ambient air covered by a gas permeable layer of polyethylene terephthalate (PET).

FIG. 5 is a graphic representation of % surface reaction conversion test results for inventive compositions 97D, 98A, 98D, 98E and 99B after UV cure at UV/1635 cm− followed by thermal cure at 100° C. for 1 hour at three different test conditions namely: 1.) in ambient air without being covered by a layer of polymer; 2.) in ambient air covered by an oxygen permeable polydimethylsiloxane polymer (PDMS) to simulate a silicone rubber mold; and 3.) in ambient air covered by a gas permeable layer of polyethylene terephthalate (PET).

### DETAILED DESCRIPTION

The term “(meth)acrylate” refers to both or any one of “acrylate” and “methacrylate”.

The term “(meth)acrylic” refers to both or any one of “acrylic” and “methacrylic”.

The term “monomer” refers to a polymer building block which has a defined molecular structure and which can be reacted to form a part of a polymer.

The term “oligomer” refers to a molecule that comprises at least two repeat units.

The term “hydrocarbon or hydrocarbyl group” refers to an organic compound consisting of carbon and hydrogen. Examples of hydrocarbon groups include but are not limited to an alkyl group, such as methyl, ethyl, propyl, butyl, pentyl, hexyl, isopropyl, tertiary butyl, isobutyl and the groups alike; an o alkenyl group, such as vinyl, allyl, butenyl, pentenyl, hexenyl and the groups alike; an aralkyl group, such as benzyl, phenethyl, 2-(2,4,6-trimethylphenyl) propyl and the groups and the like; or an aryl group, such as phenyl, tolyl, and xylyl, and the like.

The term “optionally substituted” in the term of “optionally substituted hydrocarbon group” means that one or more hydrogens on the hydrocarbon group may be replaced with a corresponding number of substituents preferably selected from halogen, nitro, azido, amino, carbonyl, ester, cyano, sulfide, sulfate, sulfoxide, sulfone, sulfone groups, and the like.

The term “glass transition temperature” refers to a temperature at which a polymer transitions between a highly elastic state and a glassy state. Glass transition temperature may be measured, for example, by differential scanning calorimetry (DSC).

The composition of the present invention may generally have the following components and their amounts present:

| Component | General Range | Narrower Range |
|---|---|---|
| Multifunctional | 10-40 wt % | 20-40 wt % |
| (meth)acrylates | | |
| Multifunctional thiols | 5-40 wt % | 20-40 wt % |
| Vinyl ether | 5-40 wt % | 20-40 wt % |
| High Refractive Index | 0-80 wt % | 5-40 wt % |
| Nanofiller | | |

### Cross-Linkable Methacrylate Component

Acrylates contemplated for use in the practice of the present invention are well known in the art. See, for example, U.S. Pat. No. 5,717,034, the entire contents of which are hereby incorporated by reference herein.

The multifunctional (meth)acrylates may be present in amounts of about 10 to about 40% by weight of the total composition, desirably in amounts to about 20% to about 40% by weight and more desirably in amounts of about 25% to about 35% by weight.

Exemplary acrylates contemplated for use herein include monofunctional (meth)acrylates, difunctional (meth)acrylates, trifunctional (meth)acrylates, polyfunctional (meth)acrylates, and the like.

Exemplary difunctional (meth)acrylates include hexanediol dimethacrylate, hydroxyacryloyloxypropyl methacrylate, hexanediol diacrylate, urethane acrylate, epoxyacrylate, bisphenol A-type epoxyacrylate, modified epoxyacrylate, fatty acid-modified epoxyacrylate, amine modified bisphenol A-type epoxyacrylate, allyl methacrylate, ethylene glycol dimethacrylate, diethylene glycol dimethacrylate, ethoxylated bisphenol A dimethacrylate, tricyclodecanedimethanol dimethacrylate, glycerin dimethacrylate, polypropylene glycol diacrylate, propoxylated ethoxylated bisphenol A diacrylate, 9,9-bis(4-(2-acryloyloxyethoxy)phenyl) fluorene, tricyclodecane diacrylate, dipropylene glycol diacrylate, polypropylene glycol diacrylate, PO-modified neopentyl glycol diacrylate, tricyclodecanedimethanol diacrylate, 1,12-dodecanediol dimethacrylate, and the like.

Exemplary trifunctional (meth)acrylates include trimethylolpropane trimethacrylate, trimethylolpropane triacrylate, trimethylolpropane ethoxy triacrylate, polyether triacrylate, glycerin propoxy triacrylate, and the like.

Exemplary polyfunctional (meth)acrylates include dipentaerythritol polyacrylate, dipentaerythritol hexaacrylate, pentaerythritol tetraacrylate, pentaerythritol ethoxy tetraacrylate, ditrimethylolpropane tetraacrylate, and the like.

Additional exemplary acrylates contemplated for use in the practice of the present invention include those described in U.S. Pat. No. 5,717,034, the entire contents of which are hereby incorporated by reference herein. The multi-functional (meth)acrylate may include an epoxy acrylate.

### Multi-Functional Thiol Component

The multi-functional thiol component may be selected from the group consisting of a trifunctional thiol, a tetrafunctional thiol, a thiol-acrylate, a polymeric thiol-acrylate and combinations thereof. The multi-functional thiol component may be present in amounts of about 5% to about 40% by weight, and desirably about 5% to about 30% by weight, and more desirably about 5% to about 25% by weight of the total composition.

Additional examples of multi-functional thiols include the following commercially available compounds: Showa Denko Karenz MT PE1 (a tetrafunctional secondary thiol); Showa Denko Karenz MT NR1 (a trifunctional secondary thiol); Showa Denko Karenz MT B1 (a difunctional secondary thiol); and Allnex Ebecryl LED 02. Mixtures of multifunctional thiols are also useful.

### Photoinitiator

Suitable radical photoinitiators include Type I alpha cleavage initiators such as acetophenone derivatives such as 2-hydroxy-2-methylpropiophenone and 1-hydroxycyclohexylphenylketone; acylphosphine oxide derivatives such as bis(2,4,6 trimethylbenzoyl)phenylphosphine oxide; and benzoin ether derivatives such as benzoin methyl ether and benzoin ethyl ether. Commercially available radical photoinitiators include Irgacure 651, Irgacure 184, Irgacure 907, and Darocure 1173 from BASF.

Type II photoinitiators are also suitable, and include benzophenone, isopropylthioxanthone, and anthraquinone. Many substituted derivatives of the aforementioned compounds may also be used. The selection of a photoinitiator for the radiation curable adhesive is familiar to those skilled in the art of radiation curing. The photoinitiator system will comprise one or more photoinitiators and optionally one or more photosensitizers. The selection of an appropriate photoinitiator is highly dependent on the specific application in which the adhesive is to be used. A suitable photoinitiator is one that exhibits a light absorption spectrum that is distinct from that of the resins, and other additives in the adhesive. The amount of the photoinitiator is typically in a range of about 0.01 to about 10 parts, preferably from about 0.1 to about 5 parts, based on the 100 parts of total weight of the adhesive.

### Other Additives

Exemplary additives contemplated for use herein include diluents, fillers, antioxidants, pigments, coloring agents, plasticizers, rheology modifiers, accelerators, catalysts, monomers, polymers, block copolymers and combinations thereof.

Exemplary useful monofunctional (meth)acrylate monomers include phenylphenol acrylate, methoxypolyethylene acrylate, acryloyloxyethyl succinate, fatty acid acrylate, methacryloyloxyethylphthalic acid, phenoxyethylene glycol methacrylate, fatty acid methacrylate, carboxyethyl acrylate, isobornyl acrylate, isobutyl acrylate, t-butyl acrylate, hydroxyethyl acrylate, hydroxypropyl acrylate, dihydrocyclopentadiethyl acrylate, cyclohexyl methacrylate, t-butyl methacrylate, dimethyl aminoethyl methacrylate, diethylaminoethyl methacrylate, t-butyl aminoethyl methacrylate, 4-hydroxybutyl acrylate, tetrahydrofurfuryl acrylate, benzyl acrylate, ethylcarbitol acrylate, phenoxyethyl acrylate, methoxytriethylene glycol acrylate, monopentaerythritol acrylate, dipentaerythritol acrylate, tripentaerythritol acrylate, polypentaerythritol acrylate, and the like.

If a filler is added to the compositions, desirably it is a high refractive index filler.

Various aspects of the present invention are illustrated by the following non-limiting examples. The examples are for illustrative purposes and are not a limitation on any practice of the present invention. It will be understood that variations and modifications can be made without departing from the spirit and scope of the invention. One of ordinary skill in the art. readily knows how to synthesize or commercially obtain the reagents and components described herein.

### EXAMPLES

### Estimating Reaction Conversion Using ATR-FTIR

ATR-FTIR was used for monitoring reaction conversions. TH C═O peak at 1720 cm− is used as an internal reference, and the reduction in peak area of the acrylate C═C band at 1635 cm− is used for estimating the reaction conversion after UV and UV plus heat (UVT) cure, by following the equation shown here:

$$\% Conversion = ( 1 − \frac{{A}_{C = C , t} / {A}_{C = O , t}}{{A}_{C = C , t = 0} / {A}_{C = O , t = 0}} ) \times 100$$

The ATR-FTIR technique has a limited sample penetration depth between 0.5-5 microns. Thus, conversion at the surface may be detected. A higher conversion rate is indicated by a reduction in the C═C bands at 1635 cm− and 810 cm−, after exposure to UV radiation at about 800 mW/cm and thermal baking post UV exposure.

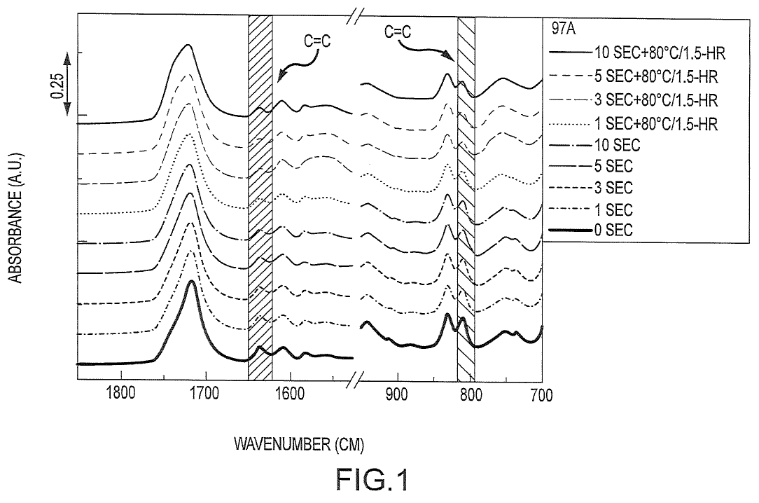

Inventive composition 97A shows a significant reduction of absorbance over time as shown in FIG. 1 after UV and UVH exposures, indicating greater reaction conversion at the surface of the adhesives which were cured in ambient air using air permeable molds, and specifically silicone rubber molds.

Conventional compositions DF-10 and DF-13A did not have a thiol-containing component present. In contrast, inventive composition 97A did contain the thiol-containing component. Their formulas are each shown below.

TABLE 1
Comparative Composition DF-10

| Component | | Weight % |
|---|---|---|
| Aromatic acrylate | 4-Phenoxybutyl | — |
| | acrylate | |
| Aromatic acrylate | CHDMMA | 5.49 |
| Epoxy acrylate | SR348 | 16.08 |
| Oligomeric urethane | CN975 | 15.97 |
| acrylate | | |
| High RI nanofiller | Zircostar ZP153 | 52.02 |
| dispersion | | |
| Photoinitiator | Omnirad 184 | 0.41 |
| Refractive Index | | 1.61 |

TABLE 2
Comparative Composition DF-13A

| Component | | Weight % |
|---|---|---|
| Aromatic acrylate | Miramer M1142 | 21.57 |
| Aromatic acrylate | CHDMMA | 9.95 |
| Epoxy acrylate | SR348 | 14.74 |
| Oligomeric epoxy acrylate | CN112C60 | 50.21 |
| with diluent | | |
| Photoinitiator | Omnirad 184 | 0.35 |
| | (previously | |
| | Irgacure 184) | |
| Aromatic acrylate | 4-Phenoxybutyl | 3.18 |
| | acrylate | |
| Refractive Index | | 1.57 |
| Surface Conversion Rate | | <20% |

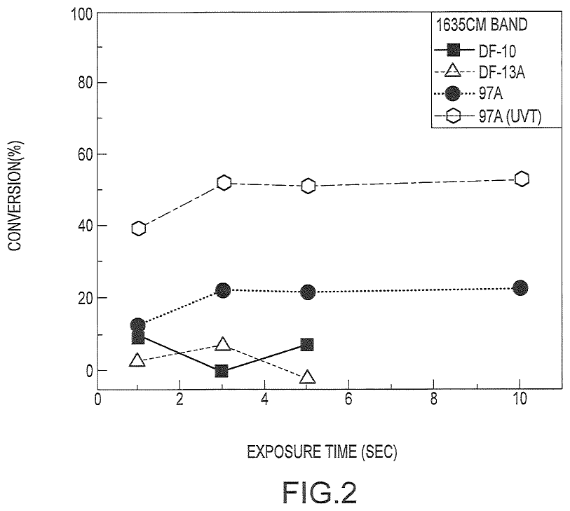

As shown in the Conversion Graph in FIG. 2, the inventive compositions exhibited a significant increase in conversion rates as compared to the non-thiol containing comparative examples. The conversion rates for the comparative compositions DF-10 and DF-13A are less than 20% when exposed to air during cure.

In contrast, the inventive compositions incorporating the thiol-containing components (thiol-acrylate) demonstrated a conversion rate of about 20% after 3 seconds of UV exposure and a conversion rate of about 50% after heat cure at 80 C for 1.5 hour.

TABLE 3
Inventive Compositions

| Component | wt % (dry basis) | 97A | 97D |
|---|---|---|---|
| Benzyl methacrylate | Visiomer BNMA | 8.81 | 8.87 |
| High RI nanofiller | Zircostar ZP153 | 47.17 | 0.00 |
| dispersion | | | |
| Phenolic antioxidant | Irganox 1010 | 0.28 | 0.28 |
| stabilizer | | | |
| Polymeric wetting/dispersing | BYK-W9010 | 0.35 | 0.35 |
| agent | | | |
| Epoxy acrylate | SR150 | 16.95 | 0.00 |
| Oligomeric epoxy acrylate | CN120D80 | 17.63 | 0.00 |
| with diluent | | | |
| Tetrafunctional thiol, | Karenz MT PE1 | 8.56 | 0.00 |
| aliphatic core | | | |
| Photoinitiator blend | Omnirad 2022 | 0.26 | 0.40 |
| | (previously | | |
| | Irgacure 2022) | | |
| Refractive Index | | 1.59 | 1.60 |
| % Surface Conversion Rate in | | — | 41% |
| Air | | | |
| Surface Conversion Rate | | 50% | 59% |
| Covered by PDMS | | | |
| (Polydimethylsilicone)- | | | |
| rubber mold air permeable | | | |
| material | | | |
| % Surface Conversion Rate | | — | 96% |
| Covered by PET (Polyethylene | | | |
| terephthalate) gas | | | |
| impermeable material | | | |

Tables 4 and 5 provide additional inventive compositions 98A-99E, each incorporating a thiol-containing component.

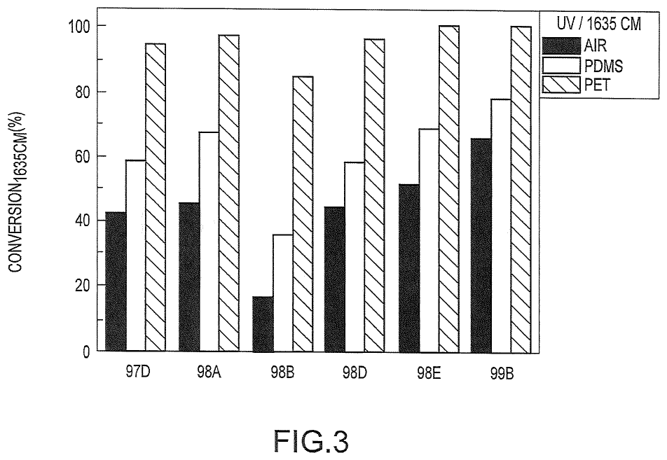

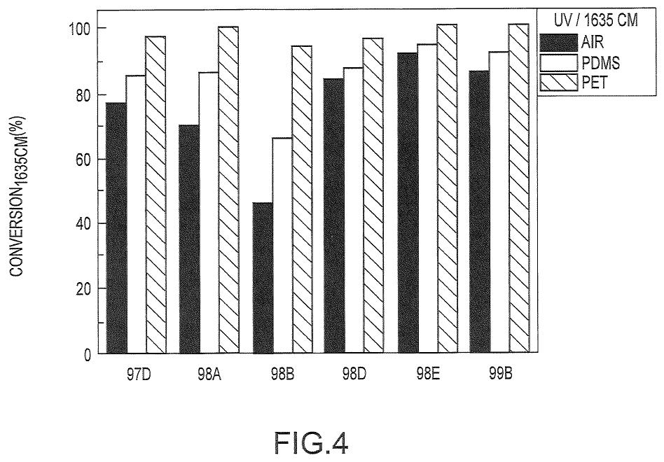

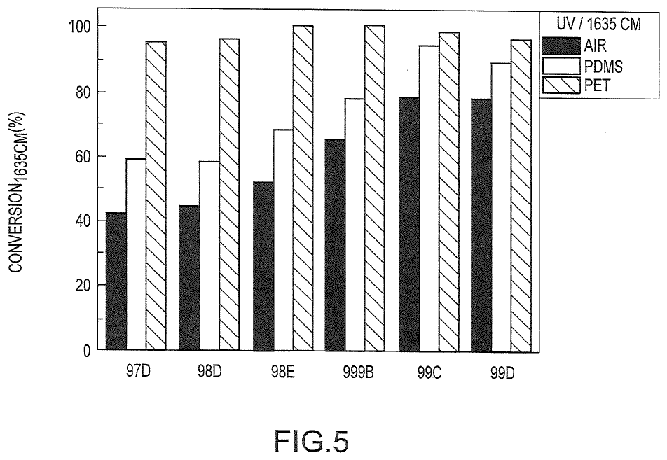

As indicated in the tables, and as graphically shown in FIGS. 3-5, the inventive compositions demonstrate considerable and surprising improvement in reaction conversion at the surface over comparative compositions DF-10 and DF-13A. Each composition was tested after cure in open air; tested after cure in ambient air while covered by an oxygen permeable silicone rubber layer (polydimethylsiloxane (PDMS)) to simulate cure in a mold; as well as being tested after cure in ambient air while covered by a layer of gas permeable polyethylene terephthalate (PET) layer.

As demonstrated from the test data recorded in the tables, the inventive thiol-containing compositions exhibit higher percentages of reaction conversion at the surface in ambient air, as compared to the comparative compositions without the inclusion of the thiol-containing component.

TABLE 4

| | wt % (dry | | | | |
|---|---|---|---|---|---|
| Component | basis) | 98A | 98B | 98D | 98E |
| Benzyl methacrylate | Visiomer BNMA | 8.83 | 8.87 | 4.90 | 4.40 |
| High RI nanofiller | Zircostar | 47.27 | 47.47 | 26.23 | 23.55 |
| dispersion | ZP153 | | | | |
| Phenolic antioxidant | Irganox 1010 | 0.28 | 0.28 | 0.16 | 0.14 |
| stabilizer | | | | | |
| Polymeric wetting/ | BYK-W9010 | 0.35 | 0.35 | 0.19 | 0.17 |
| dispersing agent | | | | | |
| Oligomeric epoxy | CN120D80 | 21.36 | 0.00 | 0.00 | 0.00 |
| acrylate with diluent | | | | | |
| Trifunctional thiol, | Karenz MT NR1 | 21.44 | 0.00 | 0.00 | 0.00 |
| aromatic core | | | | | |
| Polymeric Thiol-Acrylate | Ebecryl LED02 | 0.00 | 21.36 | 0.00 | 0.00 |
| Tetrafunctional thiol, | Karenz MT PE1 | 0.00 | 0.00 | 21.72 | 35.74 |
| aliphatic core | | | | | |
| Photoinitiator blend | Omnirad 2022 | 0.46 | 0.38 | 0.41 | 0.42 |
| | (previously | | | | |
| | Irgacure | | | | |
| | 2022) | | | | |
| Refractive Index | | 1.6 | 1.59 | 1.57 | 1.56 |
| % Surface Conversion | | 43% | 18% | 42% | 50% |
| Rate in Air | | | | | |
| % Surface Conversion | | 64% | 35% | 58% | 64% |
| Rate Covered by PDMS | | | | | |
| (Polydimethylsilicone)- | | | | | |
| rubber mold air | | | | | |
| permeable material | | | | | |
| % Surface Conversion | | 98% | 83% | 97% | 99% |
| Rate Covered by PET | | | | | |
| (Polyethylene | | | | | |
| terephthalate) gas | | | | | |
| permeable material | | | | | |

TABLE 5
Inventive Compositions

| Component | wt % (dry basis) | 99B | 99C | 99D |
|---|---|---|---|---|
| Benzyl methacrylate | Visiomer BNMA | 4.38 | 4.38 | 4.38 |
| High RI nanofiller dispersion | Zircostar ZP153 | 23.46 | 0.00 | 0.00 |
| Phenolic antioxidant | Irganox 1010 | 0.14 | 0.14 | 0.14 |
| stabilizer | | | | |
| Polymeric wetting/dispersing | BYK-W9010 | 0.17 | 0.17 | 0.17 |
| agent | | | | |
| Oligomeric epoxy acrylate | CN120D80 | 31.28 | 4.33 | 0.00 |
| with diluent | | | | |
| Tetrafunctional thiol, | Karenz MT PE1 | 35.82 | 35.82 | 35.82 |
| aliphatic core | | | | |
| Vinyl ether Acrylate hybrid | 2-(2-Vinyloxyethoxy)ethyl | 4.33 | 0.00 | 0.00 |
| monomer | acrylate [VEEA] | | | |
| Oligomeric epoxy acrylate | CN151 | 0.00 | 0.00 | 4.33 |
| Photoinitiator blend | Omnirad 2022 (previously | 0.42 | 0.42 | 0.42 |
| | Irgacure 2022) | | | |
| Refractive Index | | 1.56 | 1.55 | 1.55 |
| % Surface Conversion Rate in | | 63% | 75% | 78% |
| Air | | | | |
| % Surface Conversion Rate | | 75% | 94% | 86% |
| Covered by PDMS | | | | |
| (Polydimethylsilicone)-rubber | | | | |
| mold air permeable material | | | | |
| % Surface Conversion Rate | | 99% | 97% | 93% |
| Covered by PET (Polyethylene | | | | |
| terephthalate) gas | | | | |
| impermeable material | | | | |

What is claimed is:

1. An oxygen resistant, non-yellowing optical adhesive composition comprising
a multi-functional component selected from the group consisting of a multi-functional thiol, a multi-functional thiol-vinyl ether, multi-functional thiol-allyl ether, and combination thereof, wherein the component is present in amounts of about 5% to about 40% by weight of the total composition;
a multifunctional (meth)acrylate component; and
a photoinitiator;
wherein upon photo-curing the composition in the presence of oxygen at the adhesive surface, the compositions exhibit oxygen resistance as evidenced by a percent reaction conversion at the composition surface of at least 40% and wherein the composition when cured has a refractive index (RI) of 1.6≥RI≥1.55.

2. The composition of claim 1, wherein upon photo-curing the composition in the presence of oxygen at the adhesive surface, the compositions exhibit oxygen resistance as evidenced by a reaction conversion at the adhesive surface of at least 60% when the adhesive surface is subjected to oxygen exposure.

3. The composition of claim 1, wherein upon photo-curing the composition in the presence of oxygen at the adhesive surface, the compositions exhibit oxygen resistance as evidenced by a reaction conversion at the adhesive surface of at least 80% when the adhesive surface is subjected to oxygen exposure.

4. The composition of claim 1, wherein upon photo-curing the composition in the presence of oxygen at the adhesive surface, the compositions exhibit oxygen resistance as evidenced by a reaction conversion at the adhesive surface of at least 90% when the adhesive surface is subjected to oxygen exposure.

5. The composition of claim 1, wherein multi-functional component is selected from the group consisting of a trifunctional thiol, a tetrafunctional thiol, a thiol-acrylate, a polymeric thiol-acrylate and combinations thereof.

6. The composition of claim 1, wherein the multi-functional thiol or thiol-vinyl ether component is present in amounts of about 5% to about 25% by weight of the total composition.

7. The composition of claim 1, wherein the multifunctional (meth)acrylate component is present in amounts of about 10% to about 40% by weight of the total composition.

8. The composition of claim 1, further comprising a high refractive index filler.

9. The composition of claim 1, further comprising an antioxidant.

10. The composition of claim 1, wherein the multi-functional (meth)acrylate includes an epoxy acrylate.

11. A method of molding an oxygen resistant, non-yellowing optical adhesive composition to achieve a high percentage surface conversion comprising:
a. Discharging into an oxygen-permeable mold, an oxygen resistant, non-yellowing optical adhesive composition comprising a multi-functional component selected from the group consisting of a multi-functional thiol, a multi-functional thiol-vinyl ether, multi-functional thiol-allyl ether, and combination thereof, wherein the component is present in amounts of about 5% to about 40% by weight of the total composition;
a multifunctional (meth)acrylate component; and
a photoinitiator;
b. Photo-curing the composition in the presence of oxygen to obtain a molded product which exhibit oxygen resistance as evidenced by a percent reaction conversion at the composition surface of at least 40% and has a refractive index (RI) of 1.6≥RI≥1.55.

12. The method of claim 11, further including a heat curing step.

13. The method of claim 11, wherein upon photo-curing the composition in the presence of oxygen at the adhesive surface, the compositions exhibit oxygen resistance as evidenced by a reaction conversion at the adhesive surface of at least 80%.

14. The composition of claim 11, wherein upon photo-curing the composition in the presence of oxygen at the adhesive surface, the compositions exhibit oxygen resistance as evidenced by a reaction conversion at the adhesive surface of at least 90%.

15. The composition of claim 11, wherein the multi-functional component is selected from the group consisting of a trifunctional thiol, a tetrafunctional thiol, a thiol-acrylate, a polymeric thiol-acrylate and combinations thereof.

16. The composition of claim 11, wherein the multi-functional thiol or thiol-vinyl ether component is present in amounts of about 5% to about 25% by weight of the total composition.

17. The composition of claim 11, wherein the multifunctional (meth)acrylate component is present in amounts of about 10% to about 40% by weight of the total composition.

18. The composition of claim 11, further comprising a high refractive index filler.

19. The composition of claim 11, further comprising an antioxidant.

20. The composition of claim 1, wherein the multi-functional (meth)acrylate is an epoxy acrylate.

21. An article of manufacture made by the process of claim 11.
